(19) United States
(12) Patent Application Publication
(10) Pub. No.: US 2015/0136674 A1
(43) Pub. Date: May 21, 2015

(54) Apparatuses and Methods for Purifying Liquids

(71) Applicant: University of Florida Research Foundation, Inc., Gainesville, FL (US)

(72) Inventors: Subrata Roy, Gainesville, FL (US); Poulomi Banerjee, Gainesville, FL (US); Navya Mastanaiah, Gainesville, FL (US); Ryan Durscher, Gainesville, FL (US)

(21) Appl. No.: 14/603,420

(22) Filed: Jan. 23, 2015

Related U.S. Application Data
(62) Division of application No. 13/454,408, filed on Apr. 24, 2012.
(60) Provisional application No. 61/478,656, filed on Apr. 25, 2011.

(51) Int. Cl. C02F 1/78

(52) U.S. Cl. CPC C02F 1/78; C02F 2101/103
USPC 210/192

(57) ABSTRACT

Disclosed are apparatuses and methods for purifying water. In some embodiments, the apparatuses include a chamber into which liquid to be purified can be delivered, and an ozone generator that generates ozone for mixture with the liquid in the 5 chamber, the ozone generator comprising a surface discharge device that creates ozone from air. In further embodiments, the liquid is atomized into a fine mist and mixed with the ozone to increase the rate of purification.

### CROSS-REFERENCE TO RELATED APPLICATION

This application is a divisional of and claims priority to U.S. application entitled, “Apparatuses And Methods For Purifying Liquids,” having Ser. No. 13/454,408, filed Apr. 24, 2012, which claims priority to U.S. provisional application entitled, “Apparatuses And Methods For Purifying Liquids,” having Ser. No. 61/478,656, filed Apr. 25, 2012, which is entirely incorporated herein by reference.

### BACKGROUND

Water-borne disease is one of the primary reasons for the high mortality rates in developing countries. Such diseases typically result from consumption of infected water supply. Although disinfection can be accomplished with various chemical and physical methods, resistant pathogens like giardia and cryptosporidium are difficult to eliminate. It has been observed that high concentrations of disinfectant and contact time were able to kill cysts of giardia but could not achieve effective disinfection for cryptosporidium. Furthermore water disinfection by-products (DBP) are formed when these disinfectants react with natural organic matter and iodide or bromide ions present in the source water. Alternative methods with shorter contact times need to be devised that preserve the chemical composition and also achieve high inactivation of resistant pathogens.

### BRIEF DESCRIPTION OF THE DRAWINGS

The disclosed apparatuses and methods can be better understood with reference to the following drawings. The components in the drawings are not necessarily drawn to scale.

FIG. 1 is a block diagram of a first embodiment of a liquid purification system.

FIG. 2 is a block diagram of a second embodiment of a liquid purification system.

FIG. 3A is a block diagram of a third embodiment of a liquid purification system.

FIG. 3B is a block diagram of a fourth embodiment of a liquid purification system.

FIG. 4 is a graph that illustrates the scalability of ozone generators.

FIG. 5 is a block diagram of an embodiment of an ozone generator in the form of a surface discharge actuator.

### DETAILED DESCRIPTION

As described above, current methods used to purify liquids, such as water, might not remove harmful agents that can cause water-borne diseases or illness. Disclosed herein are liquid purification apparatuses and methods that can kill such agents as well as other impurities.

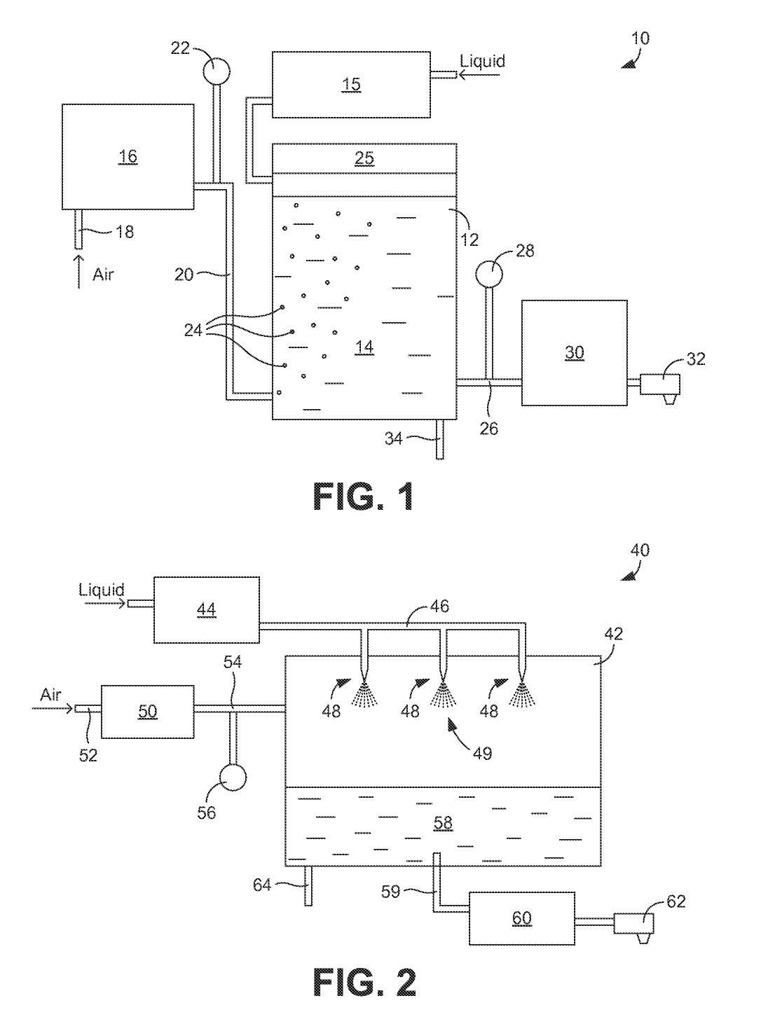

FIG. 1 illustrates a first embodiment of a liquid purification system 10. As indicated in that figure, the system 10 comprises a liquid tank 12 in which liquid 14, such as water, to be purified is contained. In some embodiments, the liquid 14 can be supplied to the tank 12 from a pretreatment unit 15 that is used to filter the liquid to remove various impurities and/or sediment from the liquid.

The system 10 further includes an ozone generator 16 that generates ozone from air supplied to the generator via an inlet 18. As described below, the ozone generator 16 can comprise one or more surface discharge devices, such as dielectric barrier discharge (DBD) devices. An example of such a device is illustrated in FIG. 5, which is described below. Irrespective of its configuration, the ozone generator 16 generates ozone that is delivered to the tank 12 via a supply line 20. In some embodiments, the flow of ozone is measured using an ozone meter 22 that is connected to the supply line 20. As is illustrated in FIG. 1, the supply line 20 can deliver the ozone to the bottom of the liquid tank 12 so that bubbles 24 of ozone percolate through the liquid 14 to purify it. In addition, the ozone oxidizes salts and chemical compounds, such as arsenic, that may be contained within the liquid. In some embodiments, residual ozone can be absorbed by an ozone scrubber 25 provided within the tank 12. The scrubber 25 can contain materials such as charcoal and titanium oxide.

Ozone-treated liquid can exit the tank 12 via an outlet line 26. In some embodiments, a further ozone meter 28 can be connected to the outlet line to detect any residual ozone contained in the liquid. The ozone-treated liquid can then be filtered by a filtration unit 30 and dispensed by a dispenser 32. With further reference to FIG. 1, an outlet 34 can be provided for clearing any sediment or by-products that collect at the bottom of the tank 12.

FIG. 2 illustrates a second embodiment of a liquid purification system 40. As indicated in FIG. 2, the system 40 comprises a liquid purification chamber 42 with which liquid is purified through ozonation. In some embodiments, the liquid is supplied to the chamber 42 with a pump 44 and a supply line 46. As is shown in FIG. 2, the supply line 46 is provided with one or more spray nozzles 48 that spray the liquid from the supply line 46 into the chamber 42 as an atomized mist 49 composed of fine droplets of liquid. By way of example, each droplet has a volume of approximately 500 nanometers (nm) to 1 millimeter (mm).

The system 40 also comprises an ozone generator 50 that generates ozone from air supplied to the generator via an inlet 52. As with the previous embodiment, the ozone generator 50 can comprise one or more surface discharge devices, such as dielectric barrier discharge (DBD) devices. Irrespective of its configuration, the ozone generator 50 generates ozone that is delivered to the chamber 42 via a supply line 54. In some embodiments, the flow of the ozone is measured using an ozone meter 56 that is connected to the supply line 54.

Within the chamber 42, the ozone supplied by the ozone generator 50 mixes with the liquid mist 49 to provide a high degree of mixing between the ozone and the liquid, which provides for a high level of purification. Because the liquid is divided into very small droplets, the surface area of the water is increased, which increases the absorption of the ozone into the liquid. This, in turn, significantly increases the rate of liquid purification. Ozone-treated liquid 58 accumulates at the bottom of the chamber 42 and can exit the chamber via an outlet line 59 that leads to a filter 60 and a dispenser 62. The chamber 42 can further include an outlet 64 that can be used to clear any sediment or by-products that collect at the bottom of the chamber.

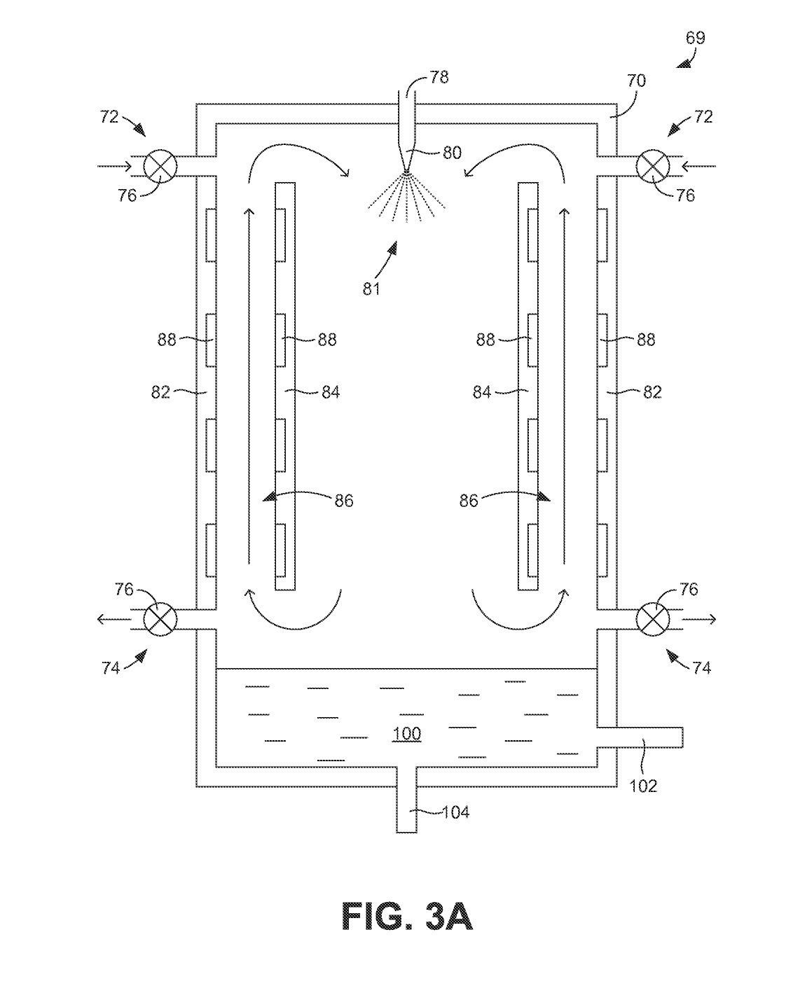

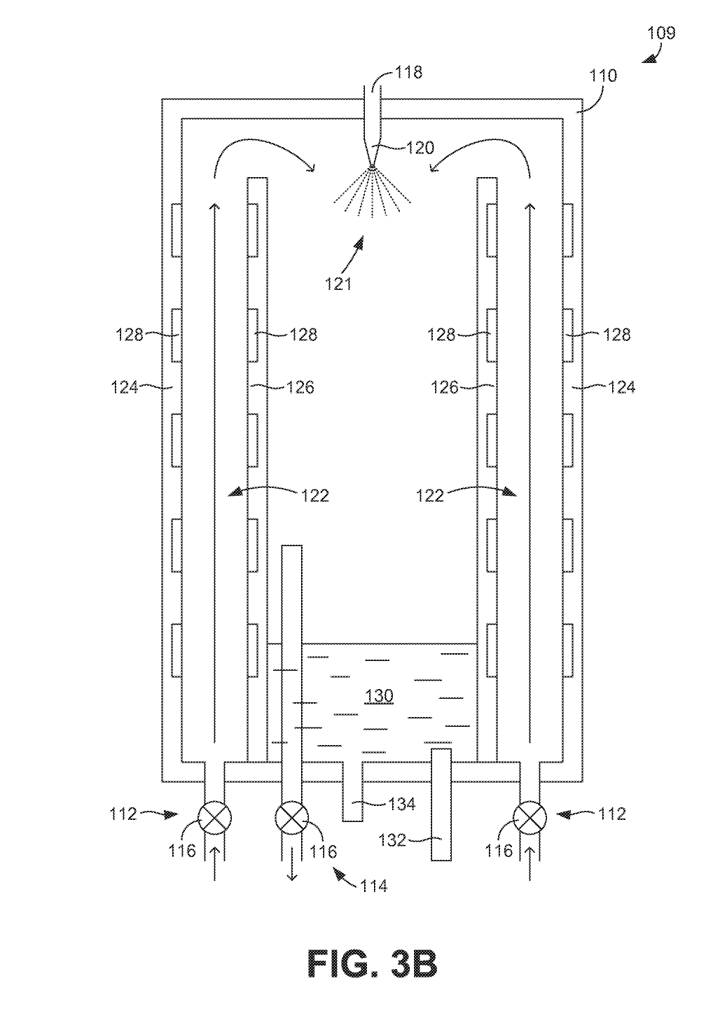

FIG. 3A illustrates a third embodiment of liquid purification system 69. As indicated in the figure, the system 69 comprises a chamber 70 that includes two air inlets 72 near the top end of the chamber 70 and two air outlets 74 near the bottom end of the chamber. In the illustrated embodiment, each inlet 72 and each outlet 74 comprises a control valve 76 that can be used to open or shut the inlet or outlet. Provided at the top end of the chamber 70 is a liquid inlet 78 that comprises at least one nozzle 80 that can be used to generate a mist 81 of fine liquid droplets, as described above in relation to FIG. 2. Formed by opposed walls 82 and 84 on each side of the chamber 70 are closed gas channels 86 through which ozone and ozonated air can flow. Each channel 86 has an inlet and an outlet. In the embodiment of FIG. 3A, the inlet is positioned within the chamber 70 near the bottom of the chamber and the outlet is positioned within chamber near the nozzle 80. Provided on the inner surfaces of the walls 82, 84 within the channels 86 are surface discharge actuators 88 that act both to generate ozone and to generate flow along the channels.

FIG. 5 illustrates an example surface discharge actuator 90. The surface discharge actuator 90 is configured as a dielectric barrier discharge (DBD) device that comprises first and second electrodes 92 and 94 that are separated by a layer of dielectric material 96. By way of example, the dielectric material 96 comprises alumina, polytetrafluoroethylene (PTFE), glass reinforced epoxy laminate sheets (e.g., FR-4), polyimide (e.g., Kapton), or poly(methyl methacrylate) (PMMA). When an electric potential or an electric field is applied across the electrodes 92, 94, an electrical discharge in the form of a plasma 98 is generated that, in the presence of air or oxygen, creates ozone. In addition, the plasma 98 creates an electrostatic force that applies a directional bias (local pressure differential) on the gas in which the device 90 is provided. Therefore, the device 90 can be used not only to generate ozone but also generate a directional flow of the ozone. In some embodiments, the flow generated by the surface discharge actuators is such that additional means, such as pumps or fans, are not needed to generate air/ozone flow. Example dielectric barrier discharge devices that are suitable for use in the disclosed systems are described in detail in U.S. 2010/0127624, U.S. 2011/0116967, and WO 2011/156408, each of which is hereby incorporated by reference into the present disclosure.

Returning to FIG. 3A, when multiple surface discharge actuators 90 are used along the channels 86, a steady flow of ozone can be generated (see flow arrows) such that ozone circulates throughout the chamber 70 and mixes with the liquid ejected from the nozzle 80. In the illustrated embodiment, the ozone flows upward through the channels 86 and directly mixes with the mist 81 to purify the liquid droplets. Ozone-treated liquid 100 can then accumulate at the bottom of the chamber 70 and can be drawn from the chamber through an outlet 102, which can include its own valve (not shown). The chamber 70 can further include an outlet 104 that can be used to clear any sediment or by-products that collect at the bottom of the chamber.

FIG. 3B illustrates a fourth embodiment of liquid purification system 109. As indicated in FIG. 3B, the system 109 comprises a chamber 110 that includes two air inlets 112 and one outlet 114 near the bottom end of the chamber, each having an associated control valve 116. Provided at the top end of the chamber 110 is a liquid inlet 118 that comprises at least one nozzle 120 that can be used to generate a mist 121 of fine liquid droplets

In similar manner to the embodiment of FIG. 3A, the chamber 110 comprises closed gas channels 122 formed by opposed walls 124 and 126 through which ozone and ozonated air can flow. Each channel 122 has an inlet and an outlet. In the embodiment of FIG. 3B, the inlet is positioned outside of the chamber 110 near the bottom of the chamber and the outlet is positioned within chamber near the nozzle 120. Provided on the inner surfaces of the walls 124, 126 within the channels 122 are surface discharge actuators 128 that can be of similar construction to the surface discharge actuator 90 described above. Again, the ozone flows upward through the channels 122 and directly mixes with the mist 121 to purify the liquid droplets. As with the previous embodiment, ozone-treated liquid 130 can then accumulate at the bottom of the chamber 110 and can be drawn from the chamber through an outlet 132, which can include its own valve (not shown). The chamber 110 can further include an outlet 134 that can be used to clear any sediment or by-products that collect at the bottom of the chamber.

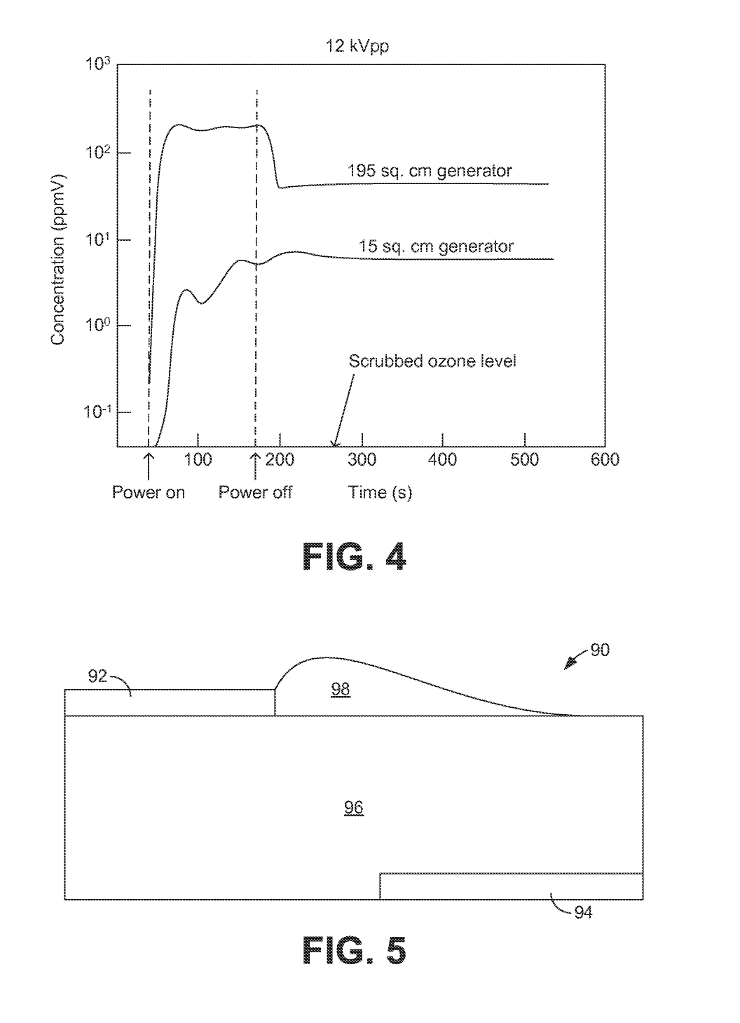

FIG. 4 is a graph that plots ozone concentration versus time for an example 15 square centimeter (cm.sup.2) surface discharge ozone generator and an example 195 cm.sup.2 surface discharge ozone generator, respectively, to provide an indication as to the effect of size of the ozone generator on ozone generation. As can be appreciated from the graph, ozone is produced at a very high rate with a surface discharge ozone generators. In some cases, ozone is produced at an order of magnitude higher rate than commercially available ozone generators.

In the foregoing disclosure, various embodiments have been described. It is noted that those embodiments are mere example implementations of the disclosed inventions and that alternative embodiments are possible. All such embodiments are intended to fall within the scope of this disclosure. In one example alternative embodiment, the chambers of FIGS. 3A and 3B can be cylindrical as can be the inner walls and the gas channels.

We claim:

1. A liquid purification system comprising:
a chamber into which liquid to be purified can be delivered;
one or more nozzles that deliver the liquid into the chamber as a mist of fine droplets; and
an ozone generator that generates ozone for mixture with the liquid in the chamber, the ozone generator comprising a surface discharge device that creates ozone from air.

2. The system of claim 1, wherein the surface discharge device is a dielectric barrier discharge device comprising first and second electrodes that are separated by a dielectric material and wherein the device generates a plasma when an electric potential is applied across the electrodes.

3. The system of claim 2, wherein the dielectric material comprises one or more of alumina, polytetrafluoroethylene, glass reinforced epoxy laminate sheets, polyimide, and poly(methyl methacrylate).

4. The system of claim 1, wherein the droplets have diameters of approximately 500 nanometers to 1 millimeter.

5. The system of claim 1, further comprising a supply line that delivers the ozone from the ozone generator to the mist.

6. The system of claim 1, wherein the ozone generator generates a directional flow of the ozone.

7. The system of claim 6, wherein the directional flow is such that additional means are not needed to generate the mixture of the ozone with the liquid.

8. The system of claim 1, wherein the ozone generator comprises multiple surface discharge devices that are provided within the chamber, the surface discharge devices being adapted to generate an ozone flow that flows to the mist.

9. The system of claim 1, wherein the chamber comprises interior walls that form one or more closed gas channels through which air and ozone can flow to the mist, the surface discharge devices being provided on interior surfaces of the gas channels.

10. The system of claim 9, wherein each gas channel as an inlet and an outlet and wherein the surface discharge devices are positioned between the inlet and outlet.

11. The system of claim 10, wherein the inlet is positioned within the chamber and the outlet is positioned within the chamber near the one or more nozzles.

12. The system of claim 10, wherein the inlet is positioned outside of the chamber and the outlet is positioned within the chamber near the one or more nozzles.
